(19) United States
(12) Patent Application Publication
(10) Pub. No.: US 2004/0014492 A1
(43) Pub. Date: Jan. 22, 2004

(54) Method and apparatus for wireless public internet access

(76) Inventor: Michael Miskin, Sleepy Hollow, IL (US)

Correspondence Address: MICHAEL D. LAKE, 311 S. WACKER DRIVE, 53RD FLOOR, CHICAGO, IL, 60606-6622, US

(21) Appl. No.: 10/391,503

(22) Filed: Mar. 17, 2003

Related U.S. Application Data
(60) Provisional application No. 60/364,800, filed on Mar. 15, 2002.

(51) Int. Cl. H04M 1/00

(52) U.S. Cl. 455/554.1; 455/554.2; 455/555

(57) ABSTRACT

Apparatus 10 is provided for consumer access to broad-band services including the Internet. The apparatus 10 includes a telecommunication line 12 which was initially installed for connecting a payphone to the PSTN. The apparatus 10 also includes first connection equipment 16 located at the consumer access site 26. The equipment 16 provides communication from a consumer device 18-22, on telecommunication line 12 via broadband wireless transmission. Second connection equipment 24 at a distant end of the telecommunication line, for example in the CO, permits broadband transmission between the consumer device 18-22 and a destination in the PSTN or Internet 14. Methods according to the invention include transmitting and receiving (34) wireless signals to and from a consumer device, at a consumer end of a telecommunication line, which line was initially installed to connect a payphone to the publicly switched telephone network (PSTN). Further methods include transmitting (36) signals or data corresponding to the wireless signals over the telecommunications line between the consumer device and a destination.

### TECHNICAL FIELD

The present invention generally relates to apparatus for consumer connectivity to the publicly switched telephone network (PSTN) or the Internet through wireless devices, and more particularly relates to providing such access through utilization of pay telephone lines.

### BACKGROUND OF THE INVENTION

The demand for broadband or high data rates is increasing at unprecedented rates for business and entertainment. Business and personal lives are ever-more normalized with broadband services. Broadband providers always seem to be behind in meeting this demand.

At the same time, there appears to be an increasing demand by individuals that the broadband services and access they have come to rely upon become as mobile as they are required or desire to be. Accordingly, there is an increased demand for mobile voice and data communications. Cell phones, PDA's portable computers, MP3 players, and interactive game devices are examples of products spawned by these needs.

Wireless communication services started out as “Cellular” networks and eventually evolved into various technologies such as General Packet Radio Service “GPRS” (2.5G), Code Division Multiple Access “CDMA”, Multimedia Messaging Service (MMS) and 3G. 3G is the next generation under development but the significant investments made in all of these technologies have still proven to be insufficient solutions to meet the total and rapidly expanding demand for features, services, and bandwidth that mobile users want and need for mobile broadband and Internet access.

Therefore, a need exists for a technology that can contribute to, or better meet, the demand for broadband access and services, in particular mobile/portable broadband access.

Although the market dynamics in telecommunication industry are very complex, there seems to be a correlation between increasing supply of mobile/portable data and voice devices and services, and a decline in revenue for conventional PSTN wire-line service and service providers.

An even more clear connection between the deployment of portable/mobile voice services is the serious decline in payphone usage. Ironically, this has caused telecommunication lines initially installed to connect public and private payphones to the PSTN (sometimes referred to herein as “payphone lines”) to become seriously underutilized infrastructure bandwidth. However there is a problem in bringing these payphone lines to bear on the demand for bandwidth.

Because of how these payphone lines were initially configured in the PSTN and how they are administered by the phone companies, they constitute a subsystem of the PSTN, or a payphone infrastructure if you will. Exemplary indicia of this is found in many places.

For example, it is not common that the network interface device (NID) connecting these phones to the PSTN are different than those used for business or residential lines. Lines used for payphones are in a great number of instances physically routed to outdoor locations, and places of complete public access, which differs markedly from conventional business or residential lines. Because of their public nature and the distances at which they are sometimes deployed from the central switching office (CO), it is not uncommon for pay telephone lines to be constructed in a more reliable and robust construction, sometimes even using a heavier-gauge wire. Some payphone lines may be routed through a PBX differently than other business lines.

A very important point is that pay phone lines are also generally physically segregated from other lines in the CO, for ease of trouble shooting, servicing, and administering. For example it is not uncommon for the payphone lines in a given CO to be aggregated into nearby areas of a main distribution frame (MDF) in the facility. The payphone lines are also terminated in the CO by line cards which differ from business or private residential lines.

The pay phone lines and service are also typically administered by different service and business units within the phone companies.

As a result of these differences and others, it would be difficult and costly to attempt to convert these payphone lines to conventional business or residential use. Accordingly, a solution to better utilize the band width of the payphone infrastructure is still needed.

As will be understood by those of skill in the art, the invention as claimed and described below, helps to meet the needs described above, while providing further advantages to consumers and the telecommunication and broadband industries.

### SUMMARY OF THE INVENTION

According to the present invention, apparatus is provided to increase consumer access to broadband services including the Internet. The apparatus includes a telecommunication line which was initially installed for connecting a payphone station to the PSTN. At the consumer end of the telecommunication line (sometimes referred to herein as “the site,” or “consumer site”) first connection equipment permits a consumer to access the telecommunication line via wireless transmission from a portable or mobile consumer device to the telecommunication line formerly dedicated to a payphone. It is believed that the payphone itself may optionally remain connected to the consumer end of the line.

According to another aspect of the invention, the first connection equipment includes a wireless transceiver. According to another aspect of the invention, the transceiver is configured and equipped to provide a wireless local area network (WLAN). A further aspect of the invention provides that the apparatus providing the WLAN can allocate bandwidth on the telecommunication line to multiple customers.

According to another aspect of the invention, second connection equipment located at a distant end of the telecommunication line will permit transmission between the telecommunication line and a destination in the PSTN or the Internet. The second connection equipment is preferably located at a central switching office of the PSTN.

According to another aspect of the invention, the first connection equipment is located or adapted to permit a consumer to access the telecommunication line while the consumer or the consumer device is outdoors. Another aspect of the invention provides that the access can be had from within an automobile parked near the consumer site.

According to another aspect of the invention at least one consumer device utilizing a site is equipped with hardware and software for communicating consumer access information to the first connection equipment. According to another aspect of the invention, the consumer access information includes one or both of a customer identification and an account to be charged for the consumer access.

According to another aspect of the invention, an alternative billing arrangement can be made when the first consumer connection equipment includes hardware and software to provide to second communication equipment at a distant end, preferably the CO, one or both of an identification of the operator of the first connection equipment and an account to be charged for a consumer access transaction, the account being associated with the operator of the first connection equipment.

According to another aspect of the invention, the first connection equipment includes at least one voice transmission device such as a pay telephone wirelessly connected to the consumer end of the telecommunication line, such as by a transceiver, a WLAN, and the like. According to another aspect of the invention, more than one voice transmission phones are wirelessly connected to the consumer end of the line by the first connection equipment.

According to another aspect of the invention, a method of providing public access to broadband services is provided. Generally the method includes transmitting and receiving wireless signals to and from a consumer device, at a consumer end of a telecommunication line, which line was initially installed to connect a payphone to the publicly switched telephone network (PSTN). Signals or data corresponding to the wireless signals from the consumer device are transported or transmitted over the telecommunications line between the consumer device and a destination.

According to another aspect of the invention, this method includes establishing an account to be charged for a consumer transaction attempted over the telecommunication line and permitting the consumer's desired communication over the telecommunications line when a payment is established, and disallowing such communication when such payment is not established.

According to another aspect of the invention, the establishing step may include receiving from a consumer's device transmission one or both of a consumer identity and an account associated with the consumer to be charged for the intended transaction over the telecommunication line and determining a method of payment for the public access by the consumer.

According to another aspect of the invention, the method includes transmitting signals over telecommunication line identifying the operator of wireless access equipment at the consumer end of the telecommunication line as the party to be charged for access to the telecommunication line and any long distance lines or far end local lines, in connection with the consumer access transaction.

### DESCRIPTION OF THE DRAWINGS

FIG. 1 is a schematic view of a wireless public access site according to the invention; and,

FIG. 2 is a schematic view of a method of providing public access to broadband services or the Internet according to the invention.

### DETAILED DESCRIPTION OF PREFERRED EMBODIMENTS

While this invention may be susceptible to embodiments in different forms, there is shown in the drawings and described herein preferred embodiments of the invention with the understanding that the present disclosure is to be considered as an exemplification of the principles of the invention and it is not intended to limit the broad aspects of the invention to the embodiments illustrated.

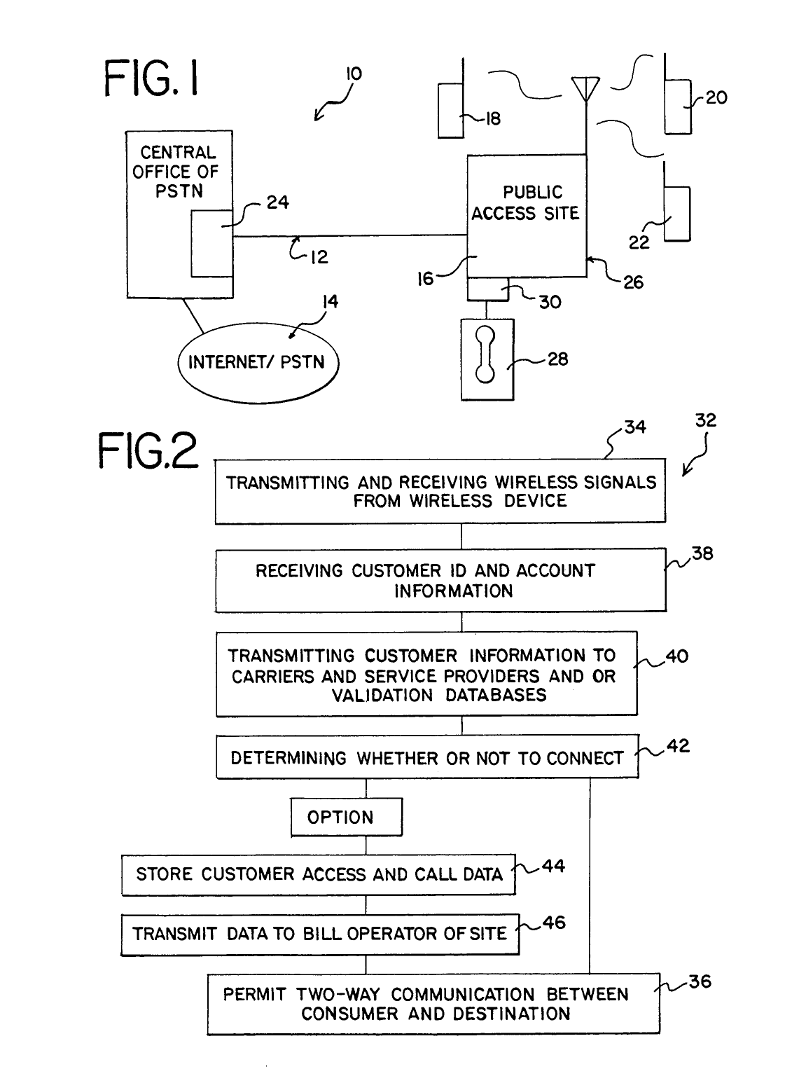

FIG. 1 discloses apparatus 10 for providing consumer access to broad-band services including the Internet. In particular the apparatus 10 includes a telecommunication line 12 which was initially installed for connecting a payphone station to the PSTN 14. First connection equipment 16 located at the consumer access end of the telecommunication line or access site 26 permits a consumer to access the telecommunication line 12 via broadband wireless transmission from a consumer devices such as devices 18, 20 and 22, to the telecommunication line 12.

Second connection equipment 24 at a distant end of the telecommunication line 12 in the central office (CO) provides for transmission between the consumer devices 18, 20, and 22 and a destination in the PSTN or Internet 14.

First connection equipment 26 can include conventional wireless transceiver adapted for wireless broadband data transmission. Advantageously, according to the invention, conventional wireless local area network (WLAN) equipment incorporated into the first connection equipment 16 along with technology such as Wireless Fidelity™, Blue Tooth™ or similar technologies, can further improve consumer utilization of the public access site 26. A preferable configuration of connection equipment 16 would permit allocation of the total available bandwidth on line 12 proportionally or non-proportionally in permitting access to the more than one consumer.

Another significant advantage of the invention is that the payphone infrastructure provides outdoor access including in many instances parking near the payphone site. Accordingly, the public access site 26 can be accessed by both handheld portable/mobile and vehicular electronic devices.

The portable devices 18, 20, and 22 could be any device such as computers, cell phones PDA's and the like. According to one aspect of the invention these devices 18-22, include sufficient hardware and software for communicating consumer access information to the first connection equipment 16 and that equipment 16 is equipped to receive the information. The consumer access information at a minimum should include one or both of a customer identifier or an identification of an account to be charged for the consumer access.

In turn, the first consumer connection equipment 16 includes hardware and software sufficient to provide this information to the second communication equipment 24 and then to the appropriate destinations for billing determinations. Either the first or the second connection equipment 16, 24, or both, are cooperatively equipped and adapted to connecting the consumer to its destination upon the determination of valid billing information.

In an alternate embodiment where the public access site 26 and/or the equipment 16 are owned or operated by a different entity than the entity owning or operating line 12, then the equipment 16 may optionally include hardware and software sufficient to determine whether or not to connect the consumer to its destination, to record the customer information, but to transmit information to line carriers, or downstream service providers that the owner operator of the equipment 16 is to be billed for a given consumers access. This would leave the owner/operator with the option of charging an independent rate and billing the consumer.

The second connection equipment 24 may include any of conventional broadband connecting, switching and transmission technologies such as T-carrier, DSL and Fiber technologies.

In alternate embodiment of the apparatus 10, one or more of the wireless devices, 18-22 can be stationary phones mounted at the site for carrying more normal voice transmission payphone services. This illustrates the wireless aspect of the invention in permitting expansion of the number of voice terminals without running extra copper line. Of course as shown in FIG. 1, either the original payphone 28 or a replacement payphone may be left at the site 26 whether connected wirelessly or by direct wire connection through its own NID 30.

FIG. 2 discloses a method of using the apparatus 10 and other embodiments not disclosed. Accordingly a method 32 generally includes the step 34 of transmitting and receiving wireless signals to and from a consumer device (such as 18 or 18-22), at a consumer end of a telecommunication line (such as line 12), which line was initially installed to connect a payphone to the publicly switched telephone network (PSTN). Again, in the broadest aspect of the invention the method provides step 36 of transmitting signals or data corresponding to the wireless signals over the telecommunications line between the consumer device and a destination (PSTN dialed line or Internet).

FIG. 2, also discloses that the method 32 includes the step of establishing an account to be charged for a consumer transaction attempted over the telecommunication line before continuing to step 36. In particular, the establishing step is disclosed as at least two options.

The first and second options for the establishing step both include the steps: 38 of receiving from a consumer's device transmission one or both of a consumer identity and an account associated with the consumer to be charged; and, 40 of transmitting the customer information for the intended transaction to line carriers, service providers or validation bases as is conventional for modern call transactions.

The next step 42 in both procedures is to determine whether or not to connect the consumer with its desired destination. After this point, FIG. 2 discloses two different optional paths.

The more direct path is to go directly to step 36. The optional path relates to situations where an entity other than the owner of line 12 and/or the second connection equipment owns or operates the equipment 16 and/or the site 26.

In such a scenario the method 32 includes the optional steps 44 and 46. Step 46 includes storing the customer access data (optionally temporarily storing in equipment 16) the customer access data gathered in step 38. Then the method provides for transmitting signals over telecommunication line identifying the operator/owner of the wireless access equipment (such as 16 FIG. 1) as the party to be charged for access to the telecommunication line and any long distance lines, far end local lines, service providers, or other charges in connection with the consumer's access transaction.

While the above description provides examples of how to practice the invention, other apparatus or methods will readily come to the mind of one of ordinary skill in the art in view of the above descriptions and the following claims.

I claim:

1. Apparatus for providing consumer access to broadband services including the Internet comprising:
a telecommunication line which was initially installed for connecting a payphone station to the PSTN; and,
a first connection equipment located at the consumer access end of the telecommunication line, the connection equipment facilitating a consumer to access the telecommunication line via broadband wireless transmission from a consumer device to the telecommunication line.

2. The apparatus of claim 1 including a second connection equipment at a distant end of the telecommunication line providing for transmission between the consumer device and a destination.

3. The apparatus of claim 1 wherein the destination is the Internet.

4. The apparatus of claim 1 wherein the destination is a business or residential destination.

5. The apparatus of claim 1 wherein the first connection equipment includes a wireless transceiver.

6. The apparatus of claim 1 wherein the first connection equipment is configured as a wireless local area network (WLAN) permitting more than one consumer to access the site relatively at the same time.

7. The apparatus of claim 1 wherein the second connection equipment is located at a central switching office of the PSTN.

8. The apparatus of claim 5 wherein the first connection equipment includes a WLAN and is adapted to allocate a total available bandwidth at the consumer end of the telecommunication line proportionally or non-proportionally in permitting access to the more than one consumers.

9. The apparatus of claim 1 wherein the first connection equipment is located or adapted to permit a consumer to access the telecommunication line while the consumer or the consumer device is outdoors.

10. The apparatus of claim 1 wherein the first connection equipment is located or adapted to permit a consumer to access the telecommunication line while the consumer or the consumer device is located in an automobile.

11. The apparatus of claim 1, including at least one consumer device having hardware and software for communicating consumer access information to the first connection equipment.

12. The apparatus of claim 11 wherein the consumer access information includes one or both of a customer identification and an account to be charged for the consumer access.

13. The apparatus of claim 1 wherein the first consumer connection equipment includes hardware and software to provide to the second communication equipment, one or both of an identification of the operator of the first connection equipment and an account to be charged for a consumer access transaction, the account being associated with the operator of the first connection equipment.

14. The apparatus of claim 7 wherein the second connection equipment includes a broadband connection to broadband destinations including the Internet.

15. The apparatus of claim 14 wherein the broadband connection is selected from the group of consisting of XDSL, T-carrier, and Fiber technologies or combinations thereof.

16. The apparatus of claim 8 wherein the first connection equipment is located or adapted to permit a consumer to access the telecommunication line while the consumer or the consumer device is located in an automobile.

17. The apparatus of claim 8, including at least one consumer device having hardware and software for communicating consumer access information to the first connection equipment.

18. The apparatus of claim 8, wherein the first consumer connection equipment includes hardware and software to provide to the second communication equipment, one or both of an identification of the operator of the first connection equipment and an account to be charged for a consumer access transaction, the account being associated with the operator of the first connection equipment.

19. The apparatus of claim 8, wherein the second connection equipment includes a broadband connection to broadband destinations including the Internet.

20. The apparatus of claim 1 one including at least one stationary voice transmission device such as a pay telephone operably connected to the consumer end of the telecommunication line.

21. The apparatus of claim 1 including at least one stationary voice transmission device such as a pay telephone operably connected to the consumer end of the telecommunication line by a wireless transceiver.

22. The apparatus of claim 20 including at least one stationary voice transmission device such as a pay telephone operably connected to the consumer end of the telecommunication line by a wireless transceiver.

23. A method of providing public access to broadband services comprising:
transmitting and receiving wireless signals to and from a consumer device, at a consumer end of a telecommunication line, which line was initially installed to connect a payphone to the publicly switched telephone network (PSTN); and,
transmitting signals or data corresponding to the wireless signals over the telecommunications line between the consumer device and a destination.

24. The method of claim 23 including:
establishing an account to be charged for a consumer transaction attempted over the telecommunication line; and,
permitting the consumer's desired communication over the telecommunications line when a payment is established, and disallowing such communication when such payment is not established.

25. The method of claim 24 wherein the establishing step includes:
receiving from a consumer's device transmission one or both of a consumer identity and an account associated with the consumer to be charged for the intended transaction over the telecommunication line; and,
determining a method of payment for the public access by the consumer.

26. The method of claim 24 the establishing step includes:
receiving from a wireless transmission from a consumer device attempting to access the telecommunication line, the transmission providing one or both of a consumer identity and an account associated the consumer to be charged for an intended access transaction over the telecommunication line; and,
transmitting signals over telecommunication line identifying the operator of wireless access equipment at the consumer end of the telecommunication line as the party to be charged for access to the telecommunication line and any long distance lines or far end local lines, in connection with the consumer access transaction.
